(19) United States
(12) Patent Application Publication
(10) Pub. No.: US 2023/0172224 A1
(43) Pub. Date: Jun. 8, 2023

(54) VEGETABLE EDIBLE FAT COMPOSITION

(71) Applicant: Oatly AB, MALMÖ (SE)

(72) Inventors: Sofia EHLDE, MALMÖ (SE); Karin PETERSSON, MALMÖ (SE); Zandra JUST, MALMÖ (SE)

(21) Appl. No.: 17/906,686

(22) PCT Filed: Mar. 18, 2021
(86) PCT No.: PCT/EP2021/057038

§ 371 Date: Sep. 19, 2022

(30) Foreign Application Priority Data
Mar. 18, 2020 (SE) 2050296-9

(51) Int. Cl. A23D 7/005; A23D 7/04; A23L 33/21

(52) U.S. Cl. CPC A23D 7/0053; A23D 7/0056; A23D 7/04; A23L 33/21

(57) ABSTRACT

A vegetable edible fat composition has a vegetable fat present in an amount of 50 to 90 percent by weight of the edible fat composition, an oat-derived material having dry matter in an amount of 1 to 10 percent by weight of the edible fat composition, and water. The pH of the composition is in the range from 4 to 6.5, and the composition is in form of an emulsion having an aqueous phase of water in a fat phase of the vegetable fat. The composition can be used as a spread or food preparation. A process is for manufacturing a vegetable edible fat composition.

### TECHNICAL FIELD OF INVENTION

The present invention relates to a vegetable edible fat composition, and to a process for manufacturing of a vegetable edible fat composition.

### BACKGROUND

There is a need and demand for fat for consumption and food preparation taking sustainability into account as well as health aspects. Further, there is a demand for vegetable fat and avoiding animal fat, which demand is fueled by an interest in sustainability, vegetarianism, veganism as well as for improved health.
It is known with vegetable fat for consumption and food preparation. Particularly it is known with vegetable fat used as sandwich spread and used for food preparation such as cooking and baking.
Thus, there is a need for providing vegetable edible fat for use as spread or for cooking and baking, which vegetable edible fat may be beneficial from a health perspective or be associated with reduced negative health effects as well as being sustainable from an environmental perspective. Further such vegetable edible fats should desirably be suitable for use as spreads as well as for cooking, including desirable taste and cooking properties.

### SUMMARY OF INVENTION

It is a purpose of the present invention to solve at least one problem or need of prior art. It is a further purpose to provide a vegetable edible fat composition which may be used for cooking, baking and/or as spread. It is a yet further purpose to provide such a fat which reduces negative health effects or which provides or adds to health benefits.
According to a first aspect of the present inventive concept there is provided a vegetable edible fat composition for use as spread or in food preparation. The composition comprises: a vegetable fat present in an amount of 50 to 90 percent by weight of the edible fat composition; an oat-derived material comprising dry matter in an amount of 1 to 10 percent by weight of the edible fat composition; and water. The pH of the composition is in the range from 4 to 6.5. The composition is in form of an emulsion having an aqueous phase comprising the water in a fat phase comprising the vegetable fat.

A fat amount of 50 to 90 percent by weight, allows for fat compositions for a wide range of uses and purposes to be manufactured.

The fat composition comprising an oat-derived material in an amount of 1 to 10 percent by weight allows for introduction of beneficial properties to the fat composition in form of a vegetable ingredient. The oat-derived material may provide for example flavour, colour, and texture to the fat composition, as well as, for example, providing a source of proteins, vegetable fat and fibres. For example, the oat-derived material may provide β-glucans to the fat composition, which in combination with other ingredients of the fat composition may provide health-beneficial properties, including assisting in lowering cholesterol levels and blood sugar levels. The oat-derived material further may provide natural sugars which may, for example, add to flavour to the fat composition.

Presence of water allows for the composition to be provided in form of an emulsion. Further, the presence of water and the composition being in form of an emulsion allows for water soluble ingredients, such as, for example, salt, and vitamins to efficiently be provided in the fat composition. Yet further, the emulsion allows water-soluble components from the oat base or oat-derived material to be introduced in the composition.

A pH in the range of 4 to 6.5 allows lending the fat composition stable properties, for example by reducing levels or growth of pathogens or bacteria, and further add flavor to the fat composition.

The oat-derived material may comprise dry matter in an amount of 2 to 10 percent by weight of the edible fat composition. Thereby, a particular desirable and/or beneficial composition may be achieved. Such amounts of oat-derived material may, for example, provide desirable spreadable fat compositions as well as desirable cooking fat compositions having desirable properties, and such compositions may be manufactured suitably using liquid oat bases.

The oat-derived material may comprise components selected from the group consisting of fat, saturated fat, monounsaturated fat, polyunsaturated fat, carbohydrates, sugars, preferably maltose, fibre, protein, and beta glucan, and combinations thereof. Thereby, the oat-derived material may provide, for example, fat to the composition in addition to the vegetable fat present in an amount of 50 to 90 percent by weight of the edible fat composition.

The oat-derived material may have been obtained from treatment of oat-material comprising degradation of starch of the oat material. The oat-derived material may have been obtained from treatment of oat-material comprising treatment with amylase. Amylase may act on oat material by degradation of starch present in the oat material. The oat-material may comprise micronized oats, such as, micronized, crushed or milled oat kernels. Thereby, efficient treatment with for example amylase may be realised and organoleptic properties of the fat composition may be achieved, including desirable taste and sensation when consumed. It will be appreciated that the oat-derived material may, for manufacturing of the vegetable edible fat composition, be provided in form of a liquid oat base or oat drink, or be derived from a liquid oat base or oat drink.

At least for a portion of the oat-derived material may be a fermented oat-derived material, or the oat-derived material may comprise fermented oat-derived material. All of the oat-derived material may be a fermented oat-derived material, or, for example, more than 25%, more than 40% or more than 75%, by dry weight of the oat-derived material, may be a fermented oat-derived material. For example, about 50% of the oat-derived material may be a fermented oat-derived material. The fermented oat-derived material may be a fermented liquid oat-base or fermented oat drink.

Oat-derived material comprising fermented oat-derived material may be obtained by the treatment with amylase followed by fermentation.

Inclusion of fermented oat-derived material in the fat composition may in combination with other ingredients contribute to benefits including, for example, suitable pH and taste. Fermented oat-derived material may be particularly suitable for a spreadable fat composition, and for adjusting pH in the spreadable fat composition, to pH between 4 and 6.5.

For example, α- and/or β-amylase may be used for treatment with amylase. The oat-derived material treated with amylase may comprise monosaccharides, disaccharides, for example, maltose, oligosaccharides, and/or fibre, for example β-glucans. The oat-derived material may further comprise proteins and fat from the oats. All or part of unreacted or partly reacted starch and fibres from the oats may be removed or reduced in content in the treatment of the oats or prior to the adding of oat-derived material to the vegetable edible fat composition, thereby, for example, allowing adding to beneficial flavour and organoleptic properties of the vegetable edible fat composition.

The oat-derived material may be added during manufacturing of the vegetable edible fat composition as dry matter, as partly dried matter, or as liquid. For example, the oat-derived material may be added as an aqueous liquid obtained from the treatment of oats comprising treatment by amylase, or a liquid oat-base. For example, such an aqueous liquid may comprise 5-20, 10-15, or 12-14, such as 13 percent dry matter by weight of the liquid oat-base. Providing the oat-derived material in form of liquid oat-base, for example having a dry matter within those ranges, for example 13%, may contribute to desirable properties of the edible vegetable fat composition and its manufacturing process.

Other or additional enzymes may be used in the treatment of oats, such as protein-deamidase or protein-glutaminase. Other amylases than α-and/or β-amylase may be used. Thereby, the composition of the oat-derived material may vary.

The oat-derived material may be a material which may be referred to as oat syrup, thereby having high content of sugar and low amount of fibre.

The vegetable edible fat composition may be a composition referred to as an oat-based vegetable edible fat composition.

Water present in, or comprised by, the fat composition may at least in part be from an aqueous oat-derived material, for example, a liquid oat-base, or from other liquid comprising the oat-derived material. The oat-derived material may have been added, such as during manufacturing of the fat composition, in form of a liquid oat-base or from a liquid comprising the oat-derived material. Benefits relating to use of such liquid oat-bases includes efficient manufacturing of the fat composition.

The oat-derived material may comprise beta glucan in an amount such that the level in the vegetable edible fat composition is at least 0.05, preferably 0.05 to 1, more preferably 0.05 to 0.3 percent by weight of the composition.

Such oat-derived material may be provided in form of a liquid oat base obtained or obtainable from amylase treatment of oat material in a preferred concentration of dry matter of 5 to 20, preferably 10 to 15, percent by weight of the oat base.

The vegetable fat may comprise two or more of rapeseed fat, coconut fat and shea fat. Thereby, the vegetable edible fat may be designed or composed with suitable and desirable properties.

The vegetable fat may comprise at least one, preferably two or more, type of fats selected from the group consisting of rapeseed fat, coconut fat, shea fat, oat-derived fat, such as oat oil or oat fat, sunflower oil, and combinations thereof.

The vegetable fat may be selected to consist of coconut fat alone.

The vegetable fat may comprise two or more type of fats selected from the group consisting of rapeseed fat, coconut fat, shea fat, and optionally, oat-derived fat, such as oat oil or oat fat.

Although not preferred, the vegetable fat may further be selected to include palm oil.

The vegetable fat may comprise two or more type of fats selected from the group consisting of rapeseed fat, coconut fat, shea fat, and optionally, oat-derived fat, such as oat oil or oat fat.

One or more of the fats comprised in the composition may comprise fully hydrogenated fat-components.

The vegetable fat may be selected from a group of fats not including palm tree oil. The vegetable edible fat composition may comprise the proviso that it is free from or essentially free from palm oil.

The vegetable fat may comprise 20-60% of saturated fat, 25-55% of monounsaturated fat, and 9-25% of polyunsaturated fat, by weight of the vegetable fat. Thereby, properties of the fat may be selected to suit a desired end product, such as a spreadable fat composition and/or a fat composition intended for cooking or baking. Further, melting properties may be controlled or selected.

The vegetable fat may also be selected to comprise 30-60% of saturated fat, 25-46% of monounsaturated fat, and 9-21% of polyunsaturated fat, by weight of the vegetable fat.

The composition may be in form of an emulsion comprising a fat phase and an aqueous phase in form of a water-in-oil emulsion.

The water may be present in an amount of 49 to 10 percent by weight, such as 40 to 15 percent by weight.

The composition may further comprise one or more of a pH regulating agent, an emulsifying agent, a flavouring agent, and a colouring agent. Thereby, properties of the fat composition may be controlled.

The vegetable fat may be present in an amount of 60 to 80, such as 60 to 75, percent by weight of the edible fat composition, and comprise 20-45% of saturated fat, 33-50% of monounsaturated fat, and 14-25% of polyunsaturated fat, by weight of the vegetable fat. Of the vegetable fat, 60-90%, such as for example 60-85%, by weight may be non-hydrogenated, and 10-40% by weight may be hydrogenated fat. The composition may be composed thus to have a content of solid fat within the range of 10 to 40% at 10° C., and 0.2 to 2.5% at 35° C., by weight of the vegetable fat.

Such a vegetable fat may suitably be used as a spread, for example a bread spread, for reasons including obtained melting properties. Melting properties or the content of solid fat may in part be controlled by the, thus, defined vegetable fat, in combination with other ingredients including content of water and oat-derived material, and optional additives. The vegetable edible fat composition comprising such a vegetable fat may, herein, be referred to as a spreadable fat composition. The content of solid fat may be determined using NMR.

For the spreadable fat composition, the oat-derived material may comprise dry matter in an amount of 3 to 7, for example 3 to 5, percent by weight of the edible fat composition.

For the spreadable fat composition, the oat-derived material may comprise dry matter in an amount of 3 to 5 percent by weight of the edible fat composition, and the vegetable fat may be present in an amount of 65 to 75 percent by weight of the edible fat composition, and, of the vegetable fat, 80-90% by weight may be non-hydrogenated, and 10-20 percent by weight may be hydrogenated fat.

For the spreadable fat composition, 25% or more of the oat-derived material, based on dry matter of the oat-derived material, may be fermented oat-derived material. Thereby pH may be set between 4 and 6, such as between 4 and 5.

A spreadable fat composition also may be provided wherein the vegetable fat may be present in an amount of 60 to 80, such as 60 to 75, percent by weight of the edible fat composition, and comprise 25-45% of saturated fat, 33-46% of monounsaturated fat, and 14-22% of polyunsaturated fat, by weight of the vegetable fat. Of the vegetable fat, 60-90%, such as for example 60-85%, by weight may be non-hydrogenated, and 10-40% by weight may be hydrogenated fat. The composition may be composed to have a content of solid fat within the range of 10 to 40% at 10° C., and 0.5 to 2.5% at 35° C., by weight of the vegetable fat.

It shall be appreciated that the vegetable fat may be selected such that, of the vegetable fat, 100% by weight may be non-hydrogenated. Thereby, 0% by weight, of the vegetable fat, may be hydrogenated fat.

The vegetable fat may be present in an amount of 70 to 85, such as 70 to 80, percent by weight of the edible fat composition, and comprises 40-60% of saturated fat, 25-40% of monounsaturated fat, and 10-20% of polyunsaturated fat, by weight of the vegetable fat. Of the vegetable fat, 55-75% by weight may be non-hydrogenated, and 25-45% by weight may be hydrogenated fat. The composition may be composed to have a content of solid fat within the range of 35 to 50% at 10° C., and 1 to 5% at 35° C., by weight of the vegetable fat.

Such a vegetable fat may suitably be used as a cooking or baking fat, for reasons including melting properties and water content provided for the vegetable edible fat composition. Melting properties or the content of solid fat may in part be controlled by the, thus, defined vegetable fat, in combination with other ingredients including content of water and oat-derived material, and optional additives. The vegetable edible fat composition comprising such a vegetable fat may, herein, be referred to as a cooking fat composition.

It shall be appreciated that the vegetable fat may be selected such that, of the vegetable fat, 100% by weight may be non-hydrogenated. Thereby, 0% by weight, of the vegetable fat, may be hydrogenated fat.

For the cooking fat composition, the oat-derived material may comprise dry matter in an amount of 2 to 6, for example, 2 to 4.5, or 2 to 4, percent by weight of the edible fat composition.

For the cooking fat composition, the oat-derived material may comprise dry matter in an amount of 2-4.5 percent by weight of the edible fat composition, the vegetable fat may be present in an amount of 75 to 85 percent by weight of the edible fat composition, and, of the vegetable fat, 65-75 percent by weight may be non-hydrogenated, and 25-35 percent by weight is hydrogenated fat.

A cooking fat composition may also be provided wherein the vegetable fat may be present in an amount of 70 to 85, such as 70 to 80, percent by weight of the edible fat composition, and comprises 50-60% of saturated fat, 25-35% of monounsaturated fat, and 9-15% of polyunsaturated fat, by weight of the vegetable fat. Of the vegetable fat, 55-75% by weight may be non-hydrogenated, and 25-45% by weight may be hydrogenated fat, and the composition may be composed to have a content of solid fat within the range of 35 to 50% at 10° C., and 1 to 5% at 35° C., by weight of the vegetable fat.

According to a second aspect of the present inventive concept, there is provided a process for manufacturing of a vegetable edible fat composition. The process comprises mixing of vegetable fat and an aqueous liquid, such that an emulsion is formed comprising a fat phase and an aqueous phase, wherein the vegetable fat is present in an amount of 50 to 90 percent by weight of the edible fat composition, and the aqueous phase is present in an amount of 49 to 10 percent by weight of the edible fat composition, and wherein the aqueous phase at least in part has been obtained by enzymatic treatment of a micronized oat material in aqueous liquid suspension comprising amylase, such that the aqueous phase comprises from 5 to 20 percent by weight of dry matter derived from the oat material, and; optionally, adding one or more additives prior to, during, or after the step of mixing.

Optionally water may be provided in addition to the aqueous phase.

The process may be for manufacturing of a vegetable edible fat composition as described in accordance with the first aspect.

The vegetable edible fat composition may alternatively or in addition be and be described as a plant based, a vegan, a non-dairy, a vegetarian, or a non-animal sourced edible fat composition, or combinations thereof.

### DETAILED DESCRIPTION OF THE INVENTION

The present invention will now be described more fully hereinafter. This invention may, however, be embodied in many different forms and should not be construed as limited to the embodiments set forth herein; rather, these embodiments are provided for thoroughness and completeness, and fully convey the scope of the invention to the skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.
The present inventive concepts are, at least in part, based on unexpected realisations including that by manufacturing of a vegetable fat composition as defined by the appended claims and examples and embodiments described herein, i.e. a fat composition comprising a vegetable fat phase having specific properties and a content of an oat-derived material, edible fat compositions may be provided having beneficial or desirable properties. Physical properties, such as melting properties may be varied and selected dependent on needs for the product while providing a content of oat-derived material.

As will be understood from following examples, fat compositions with a content of oat-derived material having a relatively low content of solid fat at temperatures typical of refrigerators combined with a melting sensation at temperatures closer to human body temperatures, thereby being suitable for use as spread, for example, on bread, is achievable. Other types of fat having a higher content of solid fat at room temperature is further achievable, thus enabling provision of fat compositions suitable for use, for example, in baking or cooking. It has been unexpectedly realized that such properties and fat compositions are achievable in combination with the content of oat-derived material. Further, the presence of the oat-derived material in the composition with resulting benefits have been made possible, while at the same time avoiding disadvantages. Thus, fat according to the present inventive concept, are achievable with suitable properties concerning eg. melting properties while at the same time allowing at least contributing to health benefits and/or reducing negative health effects. For example, the oat-derived material, and particularly beta glucan present in oat-derived material, may contribute to maintaining normal levels of cholesterol in blood, and according to the present inventive concepts it is possible to combine oat-derived materials and fat which together form a desirable vegetable edible fat composition, which composition further may be environmentally sustainable.

Thus, the vegetable edible fat composition according to inventive concepts and embodiments herein may be tailored such that it is characterised by being environmentally sustainable and/or with reduced negative health effects, as compared to alternative edible fats. For example, the vegetable edible fat composition according to embodiments can be chosen to reduce greenhouse gasses as compared to, for example, available fats. Further, the composition as defined herein may provide positive health aspects, particularly when combined in diet with other sources of eg. oat derived material. Thus, even though a typical or recommendable daily intake of fat is low, the intake of the vegetable edible fat composition according to the present inventive concepts and embodiments may make important contribution and addition to other food intakes during a day, for example related to intake of beta glucan.

According to a first aspect of the present inventive concept there is provided a vegetable edible fat composition for use as spread or food preparation. The composition comprises: a vegetable fat present in an amount of 50 to 90 percent by weight of the edible fat composition; an oat-derived material comprising dry matter in an amount of 1 to 10 percent by weight of the edible fat composition; and water. The pH of the composition is in the range from 4 to 6.5. The composition is in form of an emulsion having an aqueous phase, comprising the water, in a fat phase comprising the vegetable fat.

The emulsion may suitably be stabilised by means of one or more emulsifying agents. For example, lecithin, such as rapeseed lecithin may be used as emulsifying agent. Controlling and maintaining a pH between 4 and 6 provides stability or prolonged shelf-life to the fat composition. The pH of the composition may be, for example in the range from 4 to 6, or from 5 to 6. The pH may be regulated by known and suitable pH-regulating or buffering agents. By using a fermented oat-base having acidic pH as source of oat-derived material and for providing water to the aqueous phase of the vegetable edible fat composition, pH may be provided within specified ranges without or with reduced use of pH-regulating agent additive in the composition. Thereby, desirable fat composition may be realised with less or no additives and with simplified or improved manufacturing of the fat composition. A fermented oat-base may further provide desirable flavour to the fat composition.

The oat-derived material may be obtained from treatment of oats comprising treatment with amylase, for example as has been described in patent No. EP 1 383 396 B1.

Different vegetable edible fat compositions will now be described.

### EXAMPLE 1—VEGETABLE EDIBLE FAT COMPOSITION

Vegetable edible fat compositions have been manufactured by making emulsions of aqueous phases in fat. Emulsions may be manufactured by known techniques including, for example, mixing. For the experiments, fat content within the range of 50 to 90 percent by weight of the edible fat composition were used. The oat-derived materials were provided as a liquid oat-base with a dry matter content of 13 percent by weight. The liquid oat base may according to embodiments, and for this example, as calculated on an oat-base with a dry matter content of 13 percent by weight comprise the following components expressed as percent by weight of the oat base 0.6-0.8, more precisely 0.7, of fat, of which 0.12-0.16, more precisely 0.14 is saturated fat, 0.25-0.3, more precisely 0.27 is monounsaturated fat, and 0.25-0.3, more precisely 0.27 is polyunsaturated fat; 8-10, more precisely 9 of carbohydrates; 5-6, more precisely 5.5 of sugars, preferably maltose; 1-1.2, preferably, 1.1 of fibre; 1.2-1.6, more precisely 1.4 of protein; and 0.5-0,6, more precisely 0.55 of beta glucan. The sugars may essentially consist of or to a major part consist of maltose and/or glucose, preferably maltose. It shall be realised and appreciated that other oat-derived materials alternatively may be used. It may in addition be possible to use a more or less concentrated liquid oat base, and the concentration of oat-derived material in the fat compositions may be changed with addition of water. Rapeseed Lecithin was used as emulsifying agent. Rapeseed Lecithin was typically used in an amount up to 1% by weight of the fat composition, such as 0.2-0.6, such as around 0.3 or 0.5%. Other emulsifiers may be used. Lecithin, such as rapeseed, sunflower, and/or soy lecithin may be used. In some of the compositions further optional additives included salt, NaCl, vitamin and flavourings. The vegetable fat for all compositions were selected to comprise two or more fats selected from rapeseed oil, rapeseed fat, coconut fat and shea fat; and further selected from to comprise two or more fats from the group consisting of hydrogenated rapeseed fat, non-hydrogenated rapeseed fat; hydrogenated coconut fat, non-hydrogenated coconut fat, and shea fat. The vegetable fats were further selected to comprises 30-60% of saturated fat, 25-46% of monounsaturated fat, and 9-21% of polyunsaturated fat, by weight of the vegetable fat. In addition, 20-60% of saturated fat, 25-55% of monounsaturated fat, and 9-25% of polyunsaturated fat, by weight of the vegetable fat were used. Melting properties of the fat compositions were investigated by investigating levels of solid fat in the fat composition, expressed as percent of solid fat per weight of total fat content in the fat composition. 15 or 20-kg batches of fat compositions were prepared. The oat bases for provision of oat-derived material were manufactured as has been described, for example, in patent No. EP 1383396.

Vegetable edible fat compositions according to the description above comprises fat compositions described as spreadable fat compositions and cooking fat compositions.

### EXAMPLE 2a—SPREADABLE FAT COMPOSITIONS

Vegetable edible fat compositions were manufactured comprising vegetable fat present in an amount of 60 to 80 percent by weight of the edible fat composition, and to comprise 20-45% of saturated fat, 33-50% of monounsaturated fat, and 14-25% of polyunsaturated fat, by weight of the vegetable fat. Of the vegetable fat, 60-90% by weight was non-hydrogenated, and 10-40% by weight hydrogenated fat. Emulsions were made with liquid oat-base, as described in Example 1, as aqueous phase, which together with small amounts of salt and emulsifying agent constituted the balance, to 100%, in the fat composition. Thus, for example, with 70 percent vegetable fat by weight of the composition, the liquid oat base constituted approximately 30 percent by weight of the composition. The vegetable fat phases were selected from rapeseed, hydrogenated and non-hydrogenated, coconut, hydrogenated and non-hydrogenated. The, thus, achieved vegetable edible fat compositions with herein specified composition of saturated, monosaturated and polyunsaturated fats resulted in melting properties described by a content of solid fat within the range of 10 to 40% at 10° C., and 0.2 to 2.5% at 35° C., by weight of the vegetable fat. Further, the fat compositions were characterised as being suitable for spreadable fat compositions.

In other examples of a spreadable fat composition, manufactured as described above, the oat-derived material comprised dry matter in an amount of 3-5 percent by weight, in one particular example around 4 percent, of the edible fat composition, and the vegetable fat was present in an amount of 65 to 75 percent by weight of the edible fat composition, in particular around 70 percent, and, of the vegetable fat, 80-90% by weight was non-hydrogenated, and 10-20 percent by weight was hydrogenated fat. Further, 25% or more, and in particular examples 40-60%, or around 50%, of the oat-derived material, based on dry matter of the oat-derived material, was fermented oat-derived material, for the example a liquid oat-base as described above fermented with lactobacillus bacteria. In other experiments it was concluded that a spreadable fat composition could be manufactured as described in the example without fermented oat-derived material. Without fermented oat-derived material the taste was found less pleasant and pH needed to be adjusted through use of acidic additives, which could be avoided when using fermented oat-derived material.

### EXAMPLE 2b—SPREADABLE FAT COMPOSITIONS

Vegetable edible fat compositions were manufactured comprising vegetable fat present in an amount of 60 to 80 percent by weight of the edible fat composition, and to comprise 25-45% of saturated fat, 33-46% of monounsaturated fat, and 14-22% of polyunsaturated fat, by weight of the vegetable fat. Of the vegetable fat, 60-90% by weight was non-hydrogenated, and 10-40% by weight hydrogenated fat. Emulsions were made with liquid oat-base, as described in Example 1, as aqueous phase, which together with small amounts of salt and emulsifying agent constituted the balance, to 100%, in the fat composition. Thus, for example, with 70 percent vegetable fat by weight of the composition, the liquid oat base constituted approximately 30 percent by weight of the composition. The vegetable fat phases were selected from rapeseed, hydrogenated and non-hydrogenated, coconut, hydrogenated and non-hydrogenated. Optionally in some examples, Shea fat was included in addition or as an alternative to another fat type. The, thus, achieved vegetable edible fat compositions resulted in melting properties described by a content of solid fat within the range of 10 to 40% at 10° C., and 0.5 to 2.5% at 35° C., by weight of the vegetable fat. Further, the fat compositions were characterised as being suitable for spreadable fat compositions.

### EXAMPLE 3a—COOKING FAT COMPOSITIONS

Vegetable edible fat compositions were manufactured comprising vegetable fat present in an amount of 70 to 85 percent by weight of the edible fat composition, and comprise 40-60% of saturated fat, 25-40% of monounsaturated fat, and 10-20% of polyunsaturated fat, by weight of the vegetable fat. Of the vegetable fat, 55-75% by weight were non-hydrogenated, and 25-45% by weight hydrogenated fat. Emulsions were made with liquid oat-base, as described in Example 1, as aqueous phase, which together with small amounts of salt, constituted the balance, to 100%, in the fat composition. Thus, for example, with 80 percent vegetable fat by weight of the composition, the liquid oat base constituted approximately 20 percent by weight of the composition. The vegetable fat phases were selected from rapeseed, hydrogenated and non-hydrogenated, coconut, hydrogenated and non-hydrogenated, and Shea fat.

In other examples, cooking fat compositions were manufactured as described above, wherein the oat-derived material comprised dry matter in an amount of 2-4.5 percent, in a particular example around 2.5 percent, by weight of the edible fat composition, and the vegetable fat was present in an amount of 75 to 85 percent, in the particular example about 80 percent, by weight of the edible fat composition, and, of the vegetable fat, 65-75 percent by weight was non-hydrogenated, and 25-35 percent by weight was hydrogenated fat. In the one particular example, the vegetable fat contained fully dehydrogenated rape seed oil and coconut fat, non-hydrogenated coconut fat, non-hydrogenated rape seed oil. 0.5% emulsifier, for the example Rape seed Lecithin, was used.

Thus achieved vegetable edible fat compositions with specified composition of saturated, monosaturated and polyunsaturated fats resulted in melting properties described by a content of solid fat within the range of 35 to 50% at 10° C., and 1 to 5% at 35° C., by weight of the vegetable fat. Further, the fat compositions were characterised as being suitable for cooking fat compositions. The cooking fat compositions provided desirable browning during frying, believed to be the result of the composition of the vegetable edible fat composition. This is unexpected for vegetable fats.

### EXAMPLE 3b—COOKING FAT COMPOSITIONS

Vegetable edible fat compositions were manufactured comprising vegetable fat present in an amount of 70 to 90 percent by weight of the edible fat composition, and comprise 50-60% of saturated fat, 25-35% of monounsaturated fat, and 9-15% of polyunsaturated fat, by weight of the vegetable fat. Of the vegetable fat, 55-75% by weight were non-hydrogenated, and 25-45% by weight hydrogenated fat. Emulsions were made with liquid oat-base, as described in Example 1, as aqueous phase, which together with small amounts of salt, constituted the balance, to 100%, in the fat composition. Thus, for example, with 80 percent vegetable fat by weight of the composition, the liquid oat base constituted approximately 20 percent by weight of the composition. The vegetable fat phases were selected from rapeseed, hydrogenated and non-hydrogenated, coconut, hydrogenated and non-hydrogenated, and Shea fat.

Thus achieved vegetable edible fat compositions resulted in melting properties described by a content of solid fat within the range of 35 to 50% at 10° C., and 1 to 5% at 35° C., by weight of the vegetable fat. Further, the fat compositions were characterised as being suitable for cooking fat compositions. The cooking fat compositions provided browning during frying, believed to be the result of the composition of the vegetable edible fat composition. This is unexpected for vegetable fats.

1. A vegetable edible fat composition comprising:
a vegetable fat present in an amount of 50 to 90 percent by weight of the edible fat composition,
an oat-derived material comprising dry matter in an amount of 1 to 10 percent by weight of the edible fat composition, and
water,
wherein the pH of the composition is in the range from 4 to 6.5, and
wherein the composition is in form of an emulsion having an aqueous phase comprising the water in a fat phase comprising the vegetable fat.

2. The composition according to claim 1, wherein the oat-derived material comprises components selected from the group consisting of fat, saturated fat, monounsaturated fat, polyunsaturated fat, carbohydrates, sugars, preferably maltose, fibre, protein, and beta glucan, and combinations thereof.

3. The composition according to claim 1, wherein the oat-derived material is obtained by treating an oat material with amylase.

4. The composition according to claim 3, wherein the oat material comprises micronized oats.

5. The composition according to claim 1, wherein at least a portion of the oat-derived material is a fermented oat-derived material.

6. The composition according to claim 1, wherein the oat-derived material comprises beta glucan in an amount such that the level in the vegetable edible fat composition is at least 0.05 percent by weight of the composition.

7. The composition according to claim 1, wherein the vegetable fat comprises two or more of rapeseed fat, coconut fat and shea fat.

8. The composition according to claim 1, wherein the vegetable fat comprises 20-60% of saturated fat, 25-55% of monounsaturated fat, and 9-25% of polyunsaturated fat, by weight of the vegetable fat.

9. The composition according to claim 1, wherein the composition is in form of an emulsion comprising a fat phase and an aqueous phase in form of a water-in-oil emulsion.

10. The composition according to claim 1, wherein the water is present in an amount of 49 to 10 percent by weight.

11. The composition according to claim 1, wherein the composition further comprises one or more of:
a pH regulating agent,
an emulsifying agent,
a flavouring agent, and
a colouring agent.

12. The composition according to claim 1, wherein:
the vegetable fat is present in an amount of 60 to 80 percent by weight of the edible fat composition, and comprises 20-45% of saturated fat, 33-50% of monounsaturated fat, and 14-25% of polyunsaturated fat, by weight of the vegetable fat;
of the vegetable fat, 60-90% by weight is non-hydrogenated, and 10-40% by weight is hydrogenated fat, and
the composition is composed to have a content of solid fat within the range of 10 to 40% at 10° C., and 0.2 to 2.5% at 35° C., by weight of the vegetable fat.

13. The composition according to claim 12, wherein
the oat-derived material comprises dry matter in an amount of 3-5 percent by weight of the edible fat composition,
the vegetable fat is present in an amount of 65 to 75 percent by weight of the edible fat composition,
and, of the vegetable fat, 80-90% by weight is non-hydrogenated, and 10-20 percent by weight is hydrogenated fat.

14. The composition according to claim 13, wherein 25% or more of the oat-derived material, based on dry matter of the oat-derived material, is fermented oat-derived material.

15. The composition according to claim 1, wherein:
the vegetable fat is present in an amount of 70 to 85 percent by weight of the edible fat composition, and comprises 40-60% of saturated fat, 25-40% of monounsaturated fat, and 10-20% of polyunsaturated fat, by weight of the vegetable fat;
of the vegetable fat, 55-75% by weight is non-hydrogenated, and 25-45% by weight is hydrogenated fat, and
the composition is composed to have a content of solid fat within the range of 35 to 50% at 10° C., and 1 to 5% at 35° C., by weight of the vegetable fat.

16. The composition according to claim 15, wherein
the oat-derived material comprises dry matter in an amount of 2-4.5 percent by weight of the edible fat composition,
the vegetable fat is present in an amount of 75 to 85 percent by weight of the edible fat composition,
and, of the vegetable fat, 65-75 percent by weight is non-hydrogenated, and 25-35 percent by weight is hydrogenated fat.

17. A process for manufacturing a vegetable edible fat composition, the process comprising:
mixing of vegetable fat and an aqueous liquid, such that an emulsion is formed comprising a fat phase and an aqueous phase,
wherein the vegetable fat is present in an amount of 50 to 90 percent by weight of the edible fat composition, and the aqueous phase is present in an amount of 49 to 10 percent by weight of the edible fat composition, and
wherein the aqueous phase has been obtained by enzymatic treatment of a micronized oat material in aqueous liquid suspension comprising amylase, such that the aqueous phase comprises from 5-15 percent by weight of dry matter derived from the oat material, and,
optionally adding one or more additives prior to, during, or after the step of mixing.

18. The process according to claim 17 for manufacturing a vegetable edible fat composition, the composition comprising:
a vegetable fat present in an amount of 50 to 90 percent by weight of the edible fat composition,
an oat-derived material comprising dry matter in an amount of 1 to 10 percent by weight of the edible fat composition, and
water,
wherein the pH of the composition is in the range from 4 to 6.5, and
wherein the composition is in form of an emulsion having an aqueous phase comprising the water in a fat phase comprising the vegetable fat.

19. The composition of claim 1, wherein the composition is a spread or food preparation.

20. The composition according to claim 6, wherein the oat-derived material comprises beta glucan in an amount such that the level in the vegetable edible fat composition is 0.05 to 1 percent by weight of the composition.

21. The composition according to claim 6, wherein the oat-derived material comprises beta glucan in an amount such that the level in the vegetable edible fat composition is 0.05 to 0.3 percent by weight of the composition.
